(19) United States
(12) Patent Application Publication
(10) Pub. No.: US 2015/0359232 A1
(43) Pub. Date: Dec. 17, 2015

(54) WHEAT BRAN PROCESSED PRODUCT

(71) Applicant: KAO CORPORATION, Tokyo (JP)

(72) Inventors: Mioto SATO, Kita-ku (JP); Tomohiro NAKAGAWA, Funabashi-shi (JP)

(73) Assignee: KAO CORPORATION, Chuo-ku, Tokyo (JP)

(21) Appl. No.: 14/655,941

(22) PCT Filed: Dec. 26, 2013
(86) PCT No.: PCT/JP2013/084996

§ 371 Date: Jun. 26, 2015

(30) Foreign Application Priority Data
Dec. 28, 2012 (JP) 2012-287595

(51) Int. Cl. A21D 13/02; A23L 1/10

(52) U.S. Cl. CPC A21D 13/02; A23L 1/1016; A23V 2002/00

(57) ABSTRACT

A wheat bran processed product satisfying the following (a) to (d):
(a) a degree of gelatinization of 45% to 100%;
(b) a lipid content of 3.8 mass % or less;
(c) a moisture content of 2.5 mass % or more; and
(d) a grain size of 0.1 mm or more.

### FIELD OF THE INVENTION

The present invention relates to a wheat bran processed product.

### BACKGROUND OF THE INVENTION

Wheat bran is mainly composed of milled hulls of wheat, and abundantly contains insoluble dietary fiber, vitamins, minerals and the like. Thus, the wheat bran attracts attention as a health food material. However, the wheat bran has tough texture, and if eaten, hard and dry food feel remains in a mouth, and furthermore the wheat bran has a peculiar odor. Accordingly, food in which the wheat bran is mixed is generally poor in food taste.

Various techniques for improving the food taste of the wheat bran have been developed so far. For example, Patent Literature 1 describes that flavor of wheat bran has been improved by water-washing and defatting of wheat bran.

Moreover, Patent Literature 2 to 4 describe that phytic acid in wheat bran is decreased and mouth feel and flavor of the wheat bran are also improved, by blending wheat bran and water, acting auto-enzyme thereon, and then applying pressure and heat treatment, when necessary.

Further, Patent Literature 5 describes that rough texture and an offensive odor can be suppressed by heating, kneading, shearing, granulating and then milling wheat bran at 100° C. or higher.
Patent Literature 1: JP-A-62-79756 (“JP-A” means unexamined published Japanese patent application)
Patent Literature 2: JP-A-4-23958
Patent Literature 3: JP-A-5-336907
Patent Literature 4: JP-A-5-344866
Patent Literature 5: JP-A-2012-110237

### SUMMARY OF THE INVENTION

The present invention provides a wheat bran processed product satisfying the following (a) to (d):

(a) a degree of gelatinization of 45% to 100%;

(b) a lipid content of 3.8 mass % or less;

(c) a moisture content of 2.5 mass % or more; and

(d) a grain size of 0.1 mm or more.

Other and further objects, features and advantages of the invention will appear more fully from the following description.

### DESCRIPTION OF EMBODIMENTS

The present invention relates to provide a wheat bran processed product in which an odor peculiar to wheat bran is suppressed, food feel in a mouth is smoother, a remaining feeling is low in a mouth, and the wheat bran is hard to absorb saliva in a mouth and a dry feeling in a mouth is hard to sense.

In the inventions described in the above-described Patent Literature 1 to 5, the odor or mouth feel, which is regarded as a disadvantage of the wheat bran, may be improved to some extent, but a level thereof is far from satisfactory.

The present inventors found, in the wheat bran processed product in which a lipid content in the wheat bran is controlled within a specific range, while a degree of gelatinization of the wheat bran is enhanced to a specific level, that an odor peculiar to the wheat bran is low, that a remaining feeling on a tongue is low, and that, even with a low lipid content, the product is hard to absorb the saliva in a mouth, and ease of eating is significantly improved.

The present invention has been completed based on these findings.

The wheat bran processed product of the present invention has an enhanced degree of gelatinization to a specific level and the lipid content controlled within a specific range, contains a specific amount of moisture, and has a specific grain size. The wheat bran processed product of the present invention is described below in detail.

The wheat bran processed product of the present invention has the degree of gelatinization of the range of 45% to 100%. From viewpoints of further suppressing saliva absorption and the remaining feeling sensed on the tongue, the degree of gelatinization of the wheat bran processed product of the present invention is preferably 50% or more, more preferably 60% or more, further preferably 70% or more, and still further preferably 75% or more. Moreover, in consideration of a viewpoint of further suppressing the remaining feeling, the degree of gelatinization of the wheat bran processed product of the present invention is preferably 98% or less, more preferably 95% or less, and further preferably 90% or less.

The present inventors found that saliva absorbency of the wheat bran tends to decrease by adjusting the degree of gelatinization within the specific range.

“Degree of gelatinization of the wheat bran processed product” herein means a ratio of gelatinized starch in total starch in the wheat bran processed product. The degree of gelatinization can be measured by the method described in Examples described later.

In the wheat bran processed product of the present invention, the lipid content is 3.8 mass % or less. From a viewpoint of further suppressing a bran odor, the lipid content in the wheat bran processed product of the present invention is preferably 3.4 mass % or less, more preferably 3.0 mass % or less, further preferably 2.6 mass % or less, still further preferably 2.2 mass % or less, still further preferably 1.7 mass % or less, and still further preferably 1.2 mass % or less. Moreover, from a viewpoint of production efficiency, the lipid content in the wheat bran processed product of the present invention is preferably 0.1 mass % or more, more preferably 0.2 mass % or more, further preferably 0.3 mass % or more, still further preferably 0.4 mass % or more, and still further preferably 0.5 mass % or more.

The lipid content in the wheat bran processed product herein is expressed in terms of a value measured by the method described in Examples described later.

The form of the wheat bran processed product of the present invention is not particularly limited. From a viewpoint of ease of mixing the bran with various kinds of foods, the form is preferably granular. A grain size of the wheat bran processed product of the present invention is 0.1 mm or more. From the viewpoint of ease of mixing the bran with various kinds of foods, the grain size of the wheat bran processed product of the present invention is preferably 0.2 mm or more, more preferably 0.3 mm or more, further preferably 0.4 mm or more, still further preferably 0.5 mm or more, still further preferably 0.6 mm or more, and still further preferably 0.7 mm or more. Moreover, from a similar viewpoint, the grain size of the wheat bran processed product of the present invention is preferably 10 mm or less, more preferably 7 mm or less, further preferably 5 mm or less, still further preferably 3 mm or less, still further preferably 2 mm or less, still further preferably 1.5 mm or less, and still further preferably 1 mm or less.

The grain size of the wheat bran processed product can be appropriately adjusted by a degree of milling or subsequent classification. Adjustment by the degree of milling only needs to follow a direction for use of a milling machine to be used. Adjustment by classification can be performed by a conventional means such as air classification and sieving. In the case of sieving, the grain size can be adjusted depending on a mesh of a sieve to be used. For example, when the grain size of steamed bran is adjusted to 0.5 mm to 1 mm, a fraction passed through a 16-mesh sieve and not passed through a 30-mesh sieve is collected. Herein, the number count of the mesh here is in accordance with Japanese Industrial Standards (JIS Z8801-1966).

In the wheat bran processed product of the present invention, the moisture content is 2.5 mass % or more. From a viewpoint of antisepsis and mildew-proofing, the moisture content in the wheat bran processed product of the present invention is preferably 20 mass % or less, more preferably 13 mass % or less, further preferably 10 mass % or less, and still further preferably 6 mass % or less. Moreover, from a viewpoint of suppressing water absorbency, the moisture content in the wheat bran processed product of the present invention is preferably 3 mass % or more, and more preferably 4 mass % or more.

The moisture content can be measured by the method described in Examples described later.

From a viewpoint of suppressing the odor, improving the mouth feel and suppressing the water absorbency, a starch content in the wheat bran processed product of the present invention is preferably 10 mass % to 35 mass %. The starch content can be calculated by an official method such as the Atwater method.

Moreover, from a viewpoint of an advantage in health, a dietary fiber content in the wheat bran processed product of the present invention is preferably 30 mass % or more, and more preferably 35 mass % or more. Moreover, from the viewpoint of suppressing the odor, improving the mouth feel and suppressing the water absorbency, the dietary fiber content is preferably 55 mass % or less, and more preferably 53 mass % or less. The dietary fiber can be measured by an official method such as the enzymatic-gravimetric method (Prosky method).

In the wheat bran processed product of the present invention, the odor peculiar to the wheat bran is further suppressed, the mouth feel is also smoother and the remaining feeling sensed on the tongue is low, and also the saliva is hard to be absorbed, and therefore the dry feeling is hard to be sensed and the wheat bran processed product is easy to be ate.

A wheat bran-containing food can be obtained by mixing the wheat bran processed product of the present invention with various kinds of foods. The wheat bran-containing food is not particularly limited, and specific examples include baked confectionery, cereal, bread, noodles, a cake and a steamed filled dumpling.

Then, preparation of the wheat bran processed product of the present invention is described.

The wheat bran processed product of the present invention may be obtained by heating the wheat bran to a specific temperature in the coexistence of a specific amount of water.

The temperature of the above-described heat treatment is 60° C. to 150° C., and the degree of gelatinization of the wheat bran can be adjusted within the range specified in the present invention by exposing the wheat bran to a temperature in the above range. As a result, the bran odor and the remaining feeling on the tongue can be suppressed. In addition, the water absorbency of the wheat bran can be also reduced, and thus the saliva in the mouth becomes hard to be absorbed, upon eating the product, and the dry feeling is suppressed. From a viewpoint of being processed into the wheat bran processed product in which the bran odor and the remaining feeling in the mouth are lower while the water absorbency is further suppressed, the heat treatment temperature is adjusted to preferably 80° C. or higher, more preferably 90° C. or higher, further preferably 100° C. or higher, and still further preferably 115° C. or higher. Moreover, from a viewpoint of suppressing flavor deterioration caused by thermal denaturation, the heating temperature is adjusted to preferably 140° C. or lower, more preferably 130° C. or lower, and further preferably 125° C. or lower.

Moreover, an abundance ratio of the wheat bran and the water upon the heat treatment is 100 mass parts to 300 mass parts of the water based on 100 mass parts of the wheat bran. The degree of gelatinization of the wheat bran can be further positively adjusted to the range specified in the present invention by adjusting the abundance ratio to the above ratio. Moreover, from the viewpoint of being processed into the wheat bran processed product in which the bran odor and the remaining feeling in the mouth are also lower while the water absorbency is further suppressed, the abundance ratio of the wheat bran and the water upon the heat treatment is adjusted to preferably 150 mass parts or more, and more preferably 200 mass parts or more, based on 100 mass parts of the wheat bran. Moreover, from a similar viewpoint, the abundance ratio of the wheat bran and the water upon the heat treatment is adjusted to preferably 250 mass parts or less, and more preferably 240 mass parts or less, based on 100 mass parts of the wheat bran.

The time of the above-described heat treatment is appropriately adjusted according to a kind of the wheat bran, the heating temperature, the amount of water, or the like, and cannot be generally specified. The time is ordinarily 5 minutes to 60 minutes.

The wheat bran and water are preferably subjected to the above-described heat treatment in a state in which both are brought in contact with each other. The wheat bran and water are more preferably subjected to the heat treatment in a state in which the wheat bran completely absorbs water. “State in which the wheat bran completely absorbs water” here means a state in which the wheat bran is completely immersed into water, or a state in which water is wholly permeated into the wheat bran by a capillary phenomenon by bringing the wheat bran into contact with water.

In addition, the wheat bran being a raw material is ordinarily in a granular form, and a grain size thereof is preferably 0.1 mm to 2 mm.

The heat treatment can be conducted, for example, by using a pressure cooker or an autoclave.

When the lipid content in the wheat bran used as the raw material is low, the wheat bran processed product of the present invention may be obtained by the above-described heat treatment. On the other hand, when the lipid content in the wheat bran used as the raw material is too high, the wheat bran is subjected to defatting treatment and then to the above-described heat treatment, and thus the wheat bran processed product of the present invention is obtained.

A technique of the defatting treatment is not particularly limited, but the wheat bran is preferably defatted by being immersed into an organic solvent. As the organic solvent used for the defatting treatment, for example, one kind or two or more kinds selected from the group consisting of ethanol, propanol, buthanol, ethyl ether, acetone, hexane and ethylene dichloride can be used. Above all, hexane commonly used as an extraction solvent during producing fat and oil is preferred.

An amount of the organic solvent used for the defatting treatment may be appropriately adjusted according to an intended purpose, but is ordinarily 200 mass parts or more, and preferably 300 mass parts or more, based on 100 mass parts of the wheat bran. Moreover, from viewpoints of the production efficiency and economy, the amount of the organic solvent is preferably 1,000 mass parts or less based on 100 mass parts of the wheat bran.

The defatted wheat bran is subjected to the above-mentioned heat treatment after the organic solvent is evaporated to dry the bran. A method of evaporating the organic solvent to dry the bran is not particularly limited, but drying under reduced pressure and drying in vacuum are preferred.

The wheat bran processed product of the present invention can be obtained by drying the wheat bran subjected to the above-mentioned heat treatment. The method of drying the wheat bran subjected to the heat treatment is not particularly limited, but drying under reduced pressure or in vacuum is preferred. The moisture content in the dried wheat bran processed product is preferably adjusted to 2.5 mass % or more in which the moisture content is preferably adjusted in the range of a preferred moisture content in the wheat bran processed product of the present invention, as described above.

Part or whole of the starch in the wheat bran is gelatinized by the above-described heat treatment. Therefore, in the wheat bran processed product after being dried, bran grains are ordinarily adhered to each other. Accordingly, the product is preferably milled by a blender or the like. This milling is performed to adjust the grain size of the wheat bran processed product within the range of the preferred grain size in the wheat bran processed product of the present invention, as described above.

With regard to the above-mentioned embodiment, the present invention further provides the wheat bran processed product and the method of producing the wheat bran processed product as described below.

<1> A wheat bran processed product satisfying the following (a) to (d):

(a) a degree of gelatinization of 45% to 100%;

(b) a lipid content of 3.8 mass % or less;

(c) a moisture content of 2.5 mass % or more; and

(d) a grain size of 0.1 mm or more.

<2> The wheat bran processed product according to the item <1>, wherein the degree of gelatinization is preferably 50% or more, more preferably 60% or more, further preferably 70% or more, and still further preferably 75% or more.
<3> The wheat bran processed product according to the item <1> or <2>, wherein the degree of gelatinization is preferably 98% or less, more preferably 95% or less, and still further preferably 90% or less.
<4> The wheat bran processed product according to the item <1>, wherein the degree of gelatinization is preferably 50% to 98%, more preferably 60% to 95%, further preferably 70% to 90%, and still further preferably 75% to 90%.
<5> The wheat bran processed product according to any one of the items <1> to <4>, wherein the lipid content is preferably 3.4 mass % or less, more preferably 3.0 mass % or less, further preferably 2.6 mass % or less, still further preferably 2.2 mass % or less, still further preferably 1.7 mass % or less, and still further preferably 1.2 mass % or less.
<6> The wheat bran processed product according to any one of the items <1> to <5>, wherein the lipid content is preferably 0.1 mass % or more, more preferably 0.2 mass % or more, further preferably 0.3 mass % or more, still further preferably 0.4 mass % or more, and still further preferably 0.5 mass % or more.
<7> The wheat bran processed product according to any one of the items <1> to <4>, wherein the lipid content is preferably 0.1 mass % to 3.4 mass %, more preferably 0.2 mass % to 3.0 mass %, further preferably 0.3 mass % to 2.6 mass %, still further preferably 0.4 mass % to 2.2 mass %, still further preferably 0.5 mass % to 1.7 mass %, and still further preferably 0.5 mass % to 1.2 mass %.
<8> The wheat bran processed product according to any one of the items <1> to <7>, wherein the grain size is preferably 0.2 mm or more, more preferably 0.3 mm or more, further preferably 0.4 mm or more, still further preferably 0.5 mm or more, still further preferably 0.6 mm or more, and still further preferably 0.7 mm or more.
<9> The wheat bran processed product according to any one of the items <1> to <8>, wherein the grain size is preferably 10 mm or less, more preferably 7 mm or less, further preferably 5 mm or less, still further preferably 3 mm or less, still further preferably 2 mm or less, still further preferably 1.5 mm or less, and still further preferably 1 mm or less.
<10> The wheat bran processed product according to any one of the items <1> to <7>, wherein the grain size is preferably 0.1 mm to 10 mm, more preferably 0.2 mm to 10 mm, further preferably 0.3 mm to 7 mm, still further preferably 0.4 mm to 5 mm, still further preferably 0.5 mm to 3 mm, still further preferably 0.6 mm to 2 mm, still further preferably 0.7 mm to 1.5 mm, and still further preferably 0.7 mm to 1 mm.
<11> The wheat bran processed product according to any one of the items <1> to <10>, wherein the moisture content is preferably 20 mass % or less, more preferably 13 mass % or less, further preferably 10 mass % or less, and still further preferably 6 mass % or less.
<12> The wheat bran processed product according to any one of the items <1> to <11>, wherein the moisture content is preferably 3 mass % or more, and more preferably 4 mass % or more.
<13> The wheat bran processed product according to any one of the items <1> to <10>, wherein the moisture content is preferably 2.5 mass % to 20 mass %, more preferably 2.5 mass % to 13 mass %, further preferably 3 mass % to 10 mass %, and still further preferably 4 mass % to 6 mass %.
<14> The wheat bran processed product according to any one of the items <1> to <13>, wherein the starch content in the wheat bran processed product is preferably 10 mass % to 35 mass %.
<15> The wheat bran processed product according to any one of the items <1> to <14>, wherein the dietary fiber content in the wheat bran processed product is preferably 30 mass % or more, and more preferably 35 mass % or more.
<16> The wheat bran processed product according to any one of the items <1> to <15>, wherein the dietary fiber content in the wheat bran processed product is preferably 55 mass % or less, and more preferably 53 mass % or less.
<17> The wheat bran processed product according to any one of the items <1> to <14>, wherein the dietary fiber content in the wheat bran processed product is preferably 30 mass % to 55 mass %, and more preferably 35 mass % to 53 mass %.
<18> A method of producing the wheat bran processed product according to any one of the items <1> to <17>, containing the steps of:

allowing coexistence of water in an amount of 100 mass parts to 300 mass parts based on 100 mass parts of wheat bran; and

subjecting the resultant to heat treatment at 60° C. to 150° C.

<19> The method according to the item <18>, containing the steps of:

allowing coexistence of water in an amount of preferably 150 mass parts or more, and more preferably 200 mass parts or more based on 100 mass parts of the wheat bran; and

subjecting the resultant to the heat treatment at 60° C. to 150° C.

<20> The method according to the item <18> or <19>, containing the step of:

allowing coexistence of water in an amount of preferably 250 mass parts or less, and more preferably 240 mass parts or less based on 100 mass parts of the wheat bran; and

subjecting the resultant to the heat treatment at 60° C. to 150° C.

<21> The method according to the item <18>, containing the step of:

allowing coexistence of water in an amount of preferably 150 mass parts to 250 mass parts, and more preferably 200 mass parts to 240 mass parts based on 100 mass parts of the wheat bran; and

subjecting the resultant to the heat treatment at 60° C. to 150° C.

<22> The method according to any one of the items <18> to <21>, wherein the temperature of the heat treatment is preferably 80° C. or higher, more preferably 90° C. or higher, further preferably 100° C. or higher, and still further preferably 115° C. or higher.
<23> The method according to any one of the items <18> to <22>, wherein the temperature of the heat treatment temperature is preferably 140° C. or lower, more preferably 130° C. or lower, and further preferably 125° C. or lower.
<24> The method according to any one of the items <18> to <21>, wherein the temperature of the heat treatment temperature is preferably 80° C. to 140° C., more preferably 90° C. to 130° C., and further preferably 100° C. to 125° C.
<25> The method according to any one of the items <18> to <24>, wherein the time of the heat treatment is preferably 5 minutes to 60 minutes.
<26> The method according to any one of the items <18> to <25>, wherein the heat treatment is preferably applied in a state in which the wheat bran and water are brought into contact with each other.
<27> The method according to any one of the items <18> to <26>, wherein defatted wheat bran is preferably used as the wheat bran.
<28> The method according to the item <27>, wherein the defatted wheat bran is preferably one obtained by immersing the wheat bran into an organic solvent.
<29> The method according to the item <28>, wherein the organic solvent is preferably one kind or two or more kinds selected from the group consisting of ethanol, propanol, buthanol, ethyl ether, acetone, hexane and ethylene dichloride; and more preferably hexane.
<30> The method according to the item <28> or <29>, wherein the amount of the organic solvent used for defatting the wheat bran is preferably 200 mass parts or more, and more preferably 300 mass parts or more, based on 100 mass parts of the wheat bran.
<31> The method according to any one of the items <28> to <30>, wherein the amount of the organic solvent used for defatting the wheat bran is preferably 1,000 mass parts or less based on 100 mass parts of the wheat bran.
<32> The method according to any one of the items <28> to <29>, wherein the amount of the organic solvent used for defatting treatment of the wheat bran is preferably 200 mass parts to 1,000 mass parts, and more preferably 300 mass parts to 1,000 mass parts, based on 100 mass parts of the wheat bran.
<33> The method according to any one of the items <18> to <32>, containing preferably drying the obtained product after the heat treatment.
<34> The method according to the item <33>, containing preferably milling the obtained product after the drying.
<35> A food, containing the wheat bran processed product according to any one of the items <1> to <17>.
<36> The food according to the item <35>, selected from the group consisting of baked confectionery, cereal, bread, noodles, a cake and a steamed filled dumpling.

### Example

The present invention will be described in more detail based on the following examples, but the invention is not intended to be limited thereto.

### [Analysis Method]

### —Measurement of Degree of Gelatinization—

A wheat bran processed product containing, as a dried food, a starchy material in an amount of about 100 mg was taken in a Spitz tube, 10 mL of pure water was added thereto, and the resultant mixture was well ground and dispersed into water. Then, the dispersion liquid was distributed into two 50 mL-volume measuring flasks by 2 mL for each. One of them was adjusted to be in a constant volume of 25 mL using a 0.8 M acetic acid buffer (pH 6.0), and taken as a sample for measuring the degree of gelatinization. To the other one, 0.2 mL of 10 N—NaOH solution was added, and the resultant mixture was allowed to stand for 5 minutes in a hot bath at 65° C., and completely gelatinized. Then, the resultant was neutralized by adding 1 mL of 2 N acetic acid thereto, and adjusted to be in a constant volume of 25 mL using a 0.8 M acetic-acid buffer (pH 6.0), and taken as a completely gelatinized sample.

An amount of reducing sugar was measured as described below for each of the sample for measuring the degree of gelatinization and the completely gelatinized sample.

Then, 4 mL of each of the sample for measuring the degree of gelatinization and the completely gelatinized sample was taken, 1 mL of an enzyme solution was added thereto to shake the resultant mixture at 40° C. for 30 minutes to allow reaction (in which the enzyme solution was a liquid in which 51 mg of pullulanase (trade name: β-amylase #1500S, manufactured by Nagase ChemteX Corporation) and 5.1 mg of β-amylase (manufactured by Hayashibara Co., Ltd.) were dissolved into 30 mL of 0.8 M acetic-acid buffer (pH 6.0), and an insoluble portion was filtered off, and 3.4 IU of pullulanase and 2.6 IU of β-amylase were contained in 1 mL of the enzyme solution.). In a similar manner, as a sample for a control test, relative to 4 mL of the completely gelatinized sample, a fraction to which 1 mL of a thermally deactivated enzyme solution was added was prepared.

After completion of reaction, the resultant mixture was allowed to stand for 5 minutes in a boiling water bath to deactivate the enzyme, and diluted 4 times with water. Then 5 mL of a ferricyanide test solution (0.37 g of red prussiate and 20.0 g of sodium carbonate were dissolved into water and adjusted in 1 L) was added thereto, and the resultant mixture was stirred. Ferricyanide reacted with the reducing sugar, and yellow color of the solution was bleached to yield a colorless liquid. Therefore, measurement of an amount of the reducing sugar was allowed by an amount of decolorized ferricyanide. Then, the resultant liquid was heated for 10 minutes in a boiling water bath, and cooled with water, and then an absorbance at 420 nm was measured.

Based on the measured value obtained (value obtained by subtracting an absorbance of the control from the above-described absorbance), the degree of gelatinization was calculated by the following equation.

Degree of gelatinization (%)=[{(measured value of a sample for measuring the degree of gelatinization)−(measured value of a control)}×100)/{(measured value of the completely gelatinized sample)−(the measured value of the control)}]

### —Measurement of Lipid Content—

### (1) Preparation of Sample

Wheat bran or a wheat bran processed product was milled with a milling machine, and the resultant material was taken as a test sample for measuring the lipid content.

### (2) Extraction of Lipid

(I) A flask for extraction was put in a dryer previously set at 105° C., and temperature inside the dryer was confirmed to be 105° C. by temperature indicated in the dryer. Then the flask was heated for 1 hour, transferred to a desiccator, and allowed to cool to reach room temperature, and then a mass thereof was immediately measured. The operation described above was repeated to determine a constant mass.
(II) About 20 g of the test sample was weighed into an extraction thimble, and a mass thereof was measured. Absorbent cotton was put therein so as to cover the test sample therewith, and the resultant assembly was put in the dryer previously set at 105° C., and the temperature inside the dryer was confirmed to be 105° C. by the temperature indicated in the dryer. Then, the assembly was heated for 3 hours, transferred to the desiccator, and allowed to cool to reach room temperature.
(III) About 150 mL of diethyl ether was put in the flask for extraction described in the above-described (I), an extraction tube of a Soxhlet extractor (manufactured by AS ONE Corporation) in which the extraction thimble in above-described (II) was put was connected to the flask, a cooling tube was attached to the extractor, and extraction was performed for 8 hours by adjusting a temperature in a constant temperature bath to 50° C. to 60° C. such that diethyl ether fell in drops at a rate of 3 to 4 drops per second.
(IV) After completion of the extraction, the flask for extraction was disconnected and diethyl ether was removed. The flask for extraction was put in the dryer previously set at 105° C., and the temperature inside the dryer was confirmed to be 105° C. by the temperature indicated therein, and then the flask was heated for 1 hour, transferred to the desiccator, and allowed to cool to reach room temperature, and then a mass thereof was immediately measured.

The lipid content in the wheat bran processed product was calculated from the following equation.

Lipid content (mass %)=100×(W−W0)/S

W: Mass (g) of the extraction flask measured in the above-described (IV).
W0: Mass (g) of the extraction flask measured in the above-described (I).
S: Mass (g) of the test sample put in the extraction thimble.

### —Measurement of Moisture Content—

The moisture content of the wheat bran processed product was measured as described below.

About 10 g of sample was put in an aluminum container of which weight was previously measured, the total weight was accurately measured to three places of decimals, and the sample was dried at 105° C. for 3 hours by an electric dryer. Moisture was completely removed, and a weight of the resulting sample was measured wholly with the aluminum container. A total mass of the aluminum container and the sample after being dried was subtracted from a total mass of the aluminum container and the sample before being drying to calculate the moisture contained in the sample, and the moisture content (mass %) was determined.

### Reference Example

### Defatting Treatment of Wheat Bran

To 200 g of wheat bran (trade name: Wheat Bran P (lipid content: 1.2 mass %, starch content: 29.4 mass %, dietary fiber content: 35.3 mass %), manufactured by Nisshin Pharma Inc.), 800 mL of hexane was added and the wheat bran was immersed thereinto overnight. An extract was transferred together with an insoluble matter into a glass filter on which a filter paper was placed, and suction filtration was applied thereto. Then, drying was performed at 60° C. for 1 hour by using a vacuum dryer to obtain defatted wheat bran (defatted Wheat Bran P, lipid content: 0.3 mass %).

To 200 g of wheat bran (trade name: Wheat Bran M (lipid content: 5.1 mass %, starch content: 21.3 mass %, dietary fiber content: 41.7 mass %), manufactured by Nisshin Pharma Inc.), 800 mL of hexane was added and the wheat bran was immersed thereinto for 2 hours. An extract was transferred together with an insoluble matter to a glass filter on which a filter paper was placed, and suction filtration was performed. Then, drying was performed at 60° C. for 1 hour by using a vacuum dryer to obtain defatted wheat bran (defatted Wheat Bran M, lipid content: 3.5 mass %).

### Preparation Example

### Preparation of Wheat Bran Processed Product

Then, 30 g of each of commercially available wheat brans (trade name: Wheat Bran M (lipid content: 5.1 mass %, starch content: 21.3 mass %, dietary fiber content: 41.7 mass %), trade name: Wheat Bran DF (lipid content: 1.8 mass %, starch content: 19.5 mass %, dietary fiber content: 47.1 mass %) and trade name: Wheat Bran P (lipid content: 1.2 mass %, starch content: 29.4 mass %, dietary fiber content: 35.3 mass %), all manufactured by Nisshin Pharma Inc.), the above-described defatted Wheat Bran P (lipid content: 0.3 mass %), and the above-described defatted Wheat Bran M (lipid content: 3.5 mass %) were weighed, 70 g of distilled water was added to each, and the resultant mixture was subjected to heat treatment for 1 minute to 60 minutes.

A pressure cooker was used when the heating temperature was lower than 60° C., and an autoclave was used when the heating temperature was 60° C. or higher. The wheat brans after the heat treatment were dried at 60° C. for 24 hours by using a vacuum dryer.

Dried products obtained were milled by a blender, and a 16-mesh sieve and a 30-mesh sieve were used to obtain wheat bran processed products having a grain size of 0.5 mm to 1 mm (Products 1 to 15 according to this invention and Comparative Products 1 to 9) in which the degree of gelatinization and the lipid content were different. Moreover, the moisture content of each processed product was 5 mass % for all.

In addition, for preparation of Products 1 to 4 according to this invention and Comparative Products 3 and 4, Wheat Bran DF was used as raw material wheat bran. For preparation of Products 5 to 8 according to this invention and Comparative Product 5, Wheat Bran P was used as the raw material wheat bran. For preparation of Products 9 to 12 according to this invention and Comparative Products 6 and 7, the defatted Wheat Bran P was used as the raw material wheat bran. For preparation of Comparative Products 1, 2 and 9, Wheat Bran M was used as the raw material wheat bran. For preparation of Products 13 to 15 according to this invention and Comparative Product 8, the defatted Wheat Bran M was used as the raw material wheat bran.

Moreover, temperatures of the above-described heat treatment upon preparation of Products 1 to 15 according to this invention were adjusted, in this order, to 60° C., 5 minutes; 60° C., 10 minutes; 123° C., 10 minutes; 123° C., 60 minutes; 60° C., 10 minutes; 70° C., 10 minutes; 123° C., 10 minutes; 123° C., 60 minutes; 60° C., 5 minutes; 70° C., 10 minutes; 123° C., 10 minutes; 123° C., 60 minutes; 60° C., 5 minutes; 123° C., 10 minutes; and 123° C., 60 minutes.

Moreover, temperatures of the above-described heat treatment in preparation of Comparative Products 1 to 8 were adjusted, in this order, to 70° C., 30 minutes; 123° C., 10 minutes; 50° C., 1 minute; 50° C., 10 minutes; 50° C., 1 minute; 50° C., 1 minute; 60° C., 1 minute; and 50° C., 1 minute.

In addition, Comparative Product 9 was prepared using Wheat Bran M per se without applying the heat treatment or the like.

### Test Example

Sensory evaluations were conducted on each wheat bran processed product obtained in the above-described Preparation Examples. Specifically, with regard to a degree of odor peculiar to wheat bran and a feeling of absorbing saliva upon holding 0.5 g of each wheat bran processed product in a mouth, and a wheat grains-remaining feeling on a tongue after being swallowed, relative evaluations were conducted based on the following evaluation criteria by applying untreated wheat bran (Wheat Bran P) as a reference product. A mean of evaluations by three specialist panels was taken as an evaluation numerical value.

### —Odor Peculiar to Bran—

5: Odor being hardly sensed.
4: Odor being further suppressed.
3: Odor being weaker in comparison with the reference product.
2: Equivalent to the reference product.
1: Odor being sensed stronger in comparison with the reference product.

### —Feeling of Absorbing Saliva—

5: No sense of saliva being absorbed to naturally allow swallowing.
4: Less absorption of saliva, and not concerned about a dry feeling in a mouth, either.
3: Less absorption of saliva, and a dry feeling in a mouth being suppressed in comparison with the reference product.
2: Equivalent to the reference product.
1: Stronger feeling of absorbing saliva in comparison with the reference product.

### —Bran-Remaining Feeling—

5: Almost no sensing of bran grains on a tongue.
4: Somewhat sensing of bran grains on a tongue, but not significantly concerned.
3: Lower bran grains-remaining feeling sensed on a tongue in comparison with the reference product.
2: Equivalent to the reference product.
1: Stronger remaining feeling sensed on a tongue in comparison with the reference product.

TABLE 1

| | | Products according to this invention | | | | | | | |
|---|---|---|---|---|---|---|---|---|---|
| | | 1 | 2 | 3 | 4 | 5 | 6 | 7 | 8 |
| Treatment | Heat treatment | 60 | 60 | 123 | 123 | 60 | 70 | 123 | 123 |
| | temperature (° C.) | | | | | | | | |
| | Heat treatment | 5 | 10 | 10 | 60 | 10 | 10 | 10 | 60 |
| | time (min.) | | | | | | | | |
| Properties | Degree of gelatinization | 49.1 | 60.0 | 77.0 | 95.0 | 50.0 | 61.1 | 87.7 | 100.0 |
| | Lipid content (mass %) | 1.7 | 1.5 | 1.5 | 1.5 | 1.2 | 1.2 | 1.2 | 1.0 |
| Sensory | Wheat bran odor | 3 | 3.3 | 3.7 | 3.7 | 4 | 4 | 4.7 | 3.3 |
| evaluations | Feeling of absorbing saliva | 3 | 3.3 | 3.3 | 3.3 | 3.3 | 3.7 | 4.3 | 3.7 |
| | Bran-remaining | 4.3 | 4.3 | 3.7 | 3.3 | 4.7 | 4.7 | 4.3 | 3.3 |
| | feeling on tongue | | | | | | | | |

| | | Products according to this invention | | | | | | |
|---|---|---|---|---|---|---|---|---|
| | | 9 | 10 | 11 | 12 | 13 | 14 | 15 |
| Treatment | Heat treatment | 60 | 70 | 123 | 123 | 60 | 123 | 123 |
| | temperature (° C.) | | | | | | | |
| | Heat treatment | 5 | 10 | 10 | 60 | 5 | 10 | 60 |
| | time (min.) | | | | | | | |
| Properties | Degree of gelatinization | 45.7 | 65.2 | 81.8 | 96.6 | 47.0 | 79.5 | 95.6 |
| | Lipid content (mass %) | 0.3 | 0.3 | 0.3 | 0.2 | 3.5 | 3.5 | 3.5 |
| Sensory | Wheat bran odor | 3.3 | 4.7 | 4.7 | 3.7 | 3 | 3.3 | 3 |
| evaluations | Feeling of absorbing saliva | 3.3 | 3.7 | 4 | 3.7 | 3 | 3 | 3 |
| | Bran-remaining | 4 | 4.7 | 4.3 | 3 | 3.3 | 3.3 | 3 |
| | feeling on tongue | | | | | | | |

| | | Comparative Products | | | | | | | | | Reference |
|---|---|---|---|---|---|---|---|---|---|---|---|
| | | 1 | 2 | 3 | 4 | 5 | 6 | 7 | 8 | 9 | product |
| Treatment | Heat treatment | 70 | 123 | 50 | 50 | 50 | 50 | 60 | 50 | — | — |
| | temperature (° C.) | | | | | | | | | | |
| | Heat treatment | 30 | 10 | 1 | 10 | 1 | 1 | 1 | 1 | — | — |
| | time (min.) | | | | | | | | | | |
| Properties | Degree of gelatinization | 41.7 | 81.7 | 18.6 | 38.6 | 26.7 | 20.0 | 39.3 | 23.0 | 0.0 | 0 |
| | Lipid content (mass %) | 5.1 | 5.2 | 1.4 | 1.4 | 1.3 | 0.3 | 0.3 | 3.5 | 5.1 | 1.2 |
| Sensory | Wheat bran odor | 1.3 | 1.7 | 2 | 2 | 3.3 | 1.7 | 3 | 1.7 | 1 | 2 |
| evaluations | Feeling of | 1.7 | 1.7 | 2 | 2 | 2.7 | 2.3 | 2.3 | 1.7 | 1 | 2 |
| | absorbing saliva | | | | | | | | | | |
| | Bran-remaining | 3 | 3 | 3 | 3 | 3.7 | 3 | 3.3 | 2.7 | 3 | 2 |
| | feeling on tongue | | | | | | | | | | |

The wheat bran processed product of Comparative Product 1 is an example in which the degree of gelatinization was lower than that specified in the present invention, and the lipid content was higher than that specified in the present invention. In Comparative Product 1, the wheat bran odor was strong. Moreover, the feeling of absorbing saliva was also strong, and the dry feeling was sensed in the mouth.

The wheat bran processed product of Comparative Product 2 is an example in which the degree of gelatinization was within the range specified in the present invention, but the lipid content was higher than that specified in the present invention. In Comparative Product 2, the wheat bran odor was strong. Moreover, the feeling of absorbing saliva was also strong, and the dry feeling was sensed in the mouth. The results of Comparative Product 2 show that, even if the degree of gelatinization is simply increased, when the lipid content is high, the wheat bran odor is strongly sensed, the feeling of absorbing saliva is enhanced, and the dry feeling is sensed in the mouth.

The wheat bran processed products of Comparative Products 3 to 8 are examples in which the lipid content was within the range specified in the present invention, but the degree of gelatinization was lower than that specified in the present invention. In Comparative Products 3, 4, 6 and 8, no wheat bran odor was improved. Moreover, in all of Comparative Products 3 to 8, the feeling of absorbing saliva was stronger in comparison with Products according to this invention, and the dry feeling was sensed in the mouth.

The wheat bran processed product of Comparative Product 9 is a simply defatted wheat bran processed product in which the degree of gelatinization is 0. In Comparative Product 9, the wheat bran odor was strongly sensed, and the feeling of absorbing saliva was strong.

In contrast, in the wheat bran processed products of Products 1 to 15 according to this invention, good results were obtained in both of a wheat bran odor and saliva absorbency. Moreover, in Products according to this invention of which the degree of gelatinization was 90% or less, the bran grains-remaining feeling sensed on the tongue was further suppressed.

### [Influence of Grain Size]

The above-described Product 3 according to this invention was milled by a blender to prepare wheat bran processed products having a grain size of less than 0.1 mm, a grain size of 0.1 mm to 1.0 mm, a grain size of 4.75 mm to 5.6 mm and a grain size of 11.0 mm to 11.5 mm. More specifically, a fraction passed through a 149-mesh sieve was taken as the wheat bran processed product having the grain size of less than 0.1 mm, a fraction passed through a 16-mesh sieve and not passed through a 149-mesh sieve was taken as the wheat bran processed product having the grain size of 0.1 mm to 1.0 mm, and a fraction passed through a 3.5-mesh sieve and not passed through a 4-mesh sieve was taken as the wheat bran processed product having the grain size of 4.75 mm to 5.6 mm. The wheat bran processed product having the grain size of 11.0 mm to 11.5 mm was measured using a ruler, classified and collected. With regard to each wheat bran processed product obtained in the above-described Preparation Example, the wheat bran odor and the feeling of absorbing saliva were evaluated in a manner similar to the method as described in the above-described Test Example.

TABLE 2

| | | Products according | | | |
|---|---|---|---|---|---|
| | | to this invention | | | Comparative Products |
| | | Grain size | | | |
| | | 0.1 mm to | 4.75 mm to | 11.0 mm to | |
| | | 1.0 mm | 5.6 mm | 11.5 mm | Less than 0.1 mm |
| Treatment | Heat treatment temperature (° C.) | 123 | 123 | 123 | 123 |
| | Heat treatment time (min.) | 10 | 10 | 10 | 10 |
| Properties | Degree of gelatinization | 77.0 | 77.0 | 77.0 | 77.0 |
| | Lipid content (mass %) | 1.5 | 1.5 | 1.5 | 1.5 |
| Sensory | Wheat bran odor | 5 | 5 | 4 | 2 |
| evaluations | Feeling of absorbing saliva | 5 | 5 | 4 | 1 |

The results in Table 2 show that, if the grain size of the wheat bran processed product is adjusted to less than 0.1 mm, the wheat bran odor becomes stronger, and also the feeling of absorbing saliva becomes stronger.

### [Influence of Moisture Content]

In preparation of the above-described Product 3 according to this invention, the drying time in the vacuum dryer was changed to 72 hours, 24 hours, 16 hours, 9 hours and 5 hours, to obtain wheat bran processed products having the moisture contents of 1 mass %, 3 mass %, 5 mass %, 13 mass % and 20 mass %, respectively. Moreover, water was added to the above-described wheat bran in which moisture content was 1 mass % to obtain wheat bran processed products having the moisture contents of 2 mass %, 6 mass % and 10 mass %, respectively. Further, water was added to the above-described wheat bran in which moisture content was 3 mass % to obtain a wheat bran processed product having the moisture content of 4 mass %.

In nine kinds of the thus-obtained wheat bran processed products having different moisture contents, the wheat bran odor, the feeling of absorbing saliva and the remaining feeling on the tongue were evaluated in a manner similar to the method in the above-described Test Example.

The results are shown in Table 3.

Moreover, handling properties of dough upon preparing the dough of backed confectionery by using, as the raw material, the above-described nine kinds of wheat bran processed products having different moisture contents were evaluated. The dough was prepared in a manner similar to the method described in [Preparation of baked confectionery] as described later. Moreover, with regard to the evaluation of the handling properties of the dough, the evaluation was conducted by three specialist panels based on the following evaluation criteria, and a mean thereof was taken.

### —Handling Properties of Dough (Shaping Properties of Sheet Dough)—

5: Superb in shaping properties of dough, and easier in making sheet dough.
4: Excellent in shaping properties of dough, and easy in making sheet dough.
3: Somewhat good in shaping properties of dough, and capable of making sheet dough.
2: Somewhat poor in shaping properties of dough, and hard in making sheet dough.
1: Poor in shaping properties of dough, and difficult in making sheet dough.

TABLE 3

| | Comparative | | Products | | | | | | |
|---|---|---|---|---|---|---|---|---|---|
| | Products | | according to this invention | | | | | | |
| Moisture content | 1 | 2 | 3 | 4 | 5 | 6 | 10 | 13 | 20 |
| (mass %) | | | | | | | | | |
| Wheat bran odor | 5 | 5 | 5 | 5 | 5 | 5 | 5 | 4 | 3 |
| Feeling of absorbing | 1 | 2 | 3 | 4 | 4 | 4 | 4 | 4 | 5 |
| saliva | | | | | | | | | |
| Bran-remaining | 3 | 3 | 4 | 5 | 5 | 5 | 4 | 4 | 4 |
| feeling on tongue | | | | | | | | | |
| Handling properties of | 1 | 2 | 3 | 4 | 5 | 5 | 5 | 5 | 5 |
| dough | | | | | | | | | |

The results in Table 3 show that, in the case of Comparative Products having the moisture contents of 2 mass % or less, while the wheat bran odor is significantly improved, the feeling of absorbing saliva is strong. Moreover, preparation of the dough of baked confectionery by mixing the Comparative Products resulted in poor shaping properties of sheet dough.

In contrast, in the case of Products according to this invention having the moisture contents of 3 mass % to 20 mass %, all of the wheat bran odor, the feeling of absorbing saliva and the remaining feeling on the tongue were improved. Moreover, preparation of the dough of baked confectionery by mixing the Products according to this invention resulted in good shaping properties of sheet dough, and easiness in making the sheet dough.

### [Preparation of Baked Confectionery]

In HOBART mixer (N50 MIXER manufactured by HOBART GmbH), 60 g of butter (trade name: Yotsuba butter (using no cooking salt), manufactured by Yotsuba Milk Products Co., Ltd.) was subjected to mixing at a medium speed for 1 minute, and then 50 g of sugar (trade name: Refined Superfine Sugar, manufactured by Dai-Nippon Meiji Sugar Co., Ltd.) was put therein, and the resultant mixture was subjected to mixing at a medium speed for 1 minute. Here, one obtained by dissolving 1 g of baking powder (trade name: ammonium hydrogencarbonate, manufactured by Junsei Chemical Co., Ltd.) into one obtained by beating 30 g of whole egg of a hen's egg was divided into three and added thereto. More specifically, after a first portion of egg was added thereto, the resultant mixture was stirred at a medium speed for 30 seconds, and subsequently a second portion of egg was added thereto, and the resultant mixture was stirred at a medium speed for 30 seconds. After oil adhered to the wall of the mixer was scraped off, a third portion of egg was added thereto, and the resultant mixture was stirred at a low speed for 30 seconds. Subsequently, 150 g of weak flour (trade name: Violet, manufactured by Nisshin Flour Milling Inc.) and 50 g of wheat bran of the above-described Product 3 according to this invention were added thereto and the resultant mixture was stirred at a low speed for 3 minutes.

The thus-obtained dough was formed into sheet dough having a thickness of 10 mm, and the sheet dough was cut out by a metal-made cutter having a dimension of (depth×width×height=82 mm×25 mm×15 mm).

Subsequently, baking was performed under the following baking conditions.

Baking temperature: upper flame 180° C./lower flame 180° C.
Baking time: 11 minutes

When the thus-obtained baked confectionery was eaten, the wheat bran odor was suppressed, the feeling of absorbing saliva was low, and a wheat bran-remaining feeling was also not concerned.

Having described our invention as related to this embodiments, it is our intention that the invention not be limited by any of the details of the description, unless otherwise specified, but rather be construed broadly within its spirit and scope as set out in the accompanying claims.

This application claims priority on Patent Application No. 2012-287595 filed in Japan on Dec. 28, 2012, which is entirely herein incorporated by reference.

1. A wheat bran processed product satisfying the following (a) to (d):
(a) a degree of gelatinization of 45% to 100%;
(b) a lipid content of 3.8 mass % or less;
(c) a moisture content of 2.5 mass % or more; and
(d) a grain size of 0.1 mm or more.

2. The wheat bran processed product according to claim 1, wherein the moisture content is 13 mass % or less.

3. The wheat bran processed product according to claim 1, wherein the grain size is 0.2 mm to 10 mm.

4. The wheat bran processed product according to claim 1, wherein the starch content in the wheat bran processed product is 10 mass % to 35 mass %.

5. The wheat bran processed product according to claim 1, wherein the dietary fiber content in the wheat bran processed product is 30 mass % to 55 mass %.

6. The wheat bran processed product according to claim 1, wherein the degree of gelatinization is 60% to 95%.

7. The wheat bran processed product according to claim 1, wherein the lipid content is 0.1 mass % to 3.4 mass %.

8. A method of producing the wheat bran processed product according to claim 1, comprising:
allowing coexistence of water in an amount of 100 mass parts to 300 mass parts based on 100 mass parts of wheat bran; and
subjecting the resultant to heat treatment at 60° C. to 150° C.

9. The method according to claim 8, wherein the temperature of the heat treatment is 80° C. to 140° C.

10. The method according to claim 8, wherein the time of the heat treatment is 5 minutes to 60 minutes.

11. The method according to claim 8, wherein the heat treatment is applied in a state in which the wheat bran and water are brought into contact with each other.

12. The method according to claim 8, wherein defatted wheat bran is used as the wheat bran.

13. The method according to claim 12, wherein the defatted wheat bran is one obtained by immersing the wheat bran into an organic solvent.

14. The method according to claim 13, wherein the organic solvent is one kind or two or more kinds selected from the group consisting of ethanol, propanol, buthanol, ethyl ether, acetone, hexane and ethylene dichloride.

15. The method according to claim 13, wherein the amount of the organic solvent used for defatting treatment of the wheat bran is 200 mass parts to 1,000 mass parts, based on 100 mass parts of the wheat bran.

16. A food, comprising the wheat bran processed product according to claim 1.

17. A wheat bran processed product satisfying (a-1) to (d-1):
(a-1) a degree of gelatinization of 60% to 95%;
(b-1) a lipid content of 0.4 mass % to 2.2 mass %;
(c-1) a moisture content of 2.5 mass % to 13 mass %; and
(d-1) a grain size of 0.4 mm to 5 mm.

18. A wheat bran processed product satisfying (a-2) to (d-2):
(a-1) a degree of gelatinization of 75% to 95%;
(b-1) a lipid content of 0.5 mass % to 1.2 mass %;
(c-1) a moisture content of 4 mass % to 6 mass %; and
(d-1) a grain size of 0.7 mm to 1 mm.

19. The wheat bran processed product according to claim 18, wherein the starch content in the wheat bran processed product is 10 mass % to 35 mass %.

20. The wheat bran processed product according to claim 18, wherein the dietary fiber content in the wheat bran processed product is 35 mass % to 53 mass %.
